(19) United States
(12) Patent Application Publication
(10) Pub. No.: US 2026/0286144 A1
(43) Pub. Date: Sep. 24, 2026

(54) HEAT DISSIPATION COMPOSITION, AND ELECTRICAL INSULATION-HEAT DISSIPATION BODY AND HEAT DISSIPATION STRUCTURE COMPRISING HEAT DISSIPATION COMPOSITION

(71) Applicants: Hyundai Motor Company, Seoul (KR); Kia Corporation, Seoul (KR); ENPLUS CO., LTD., Hwaseong (KR)

(72) Inventors: Ji Eun Kim, Hwaseong (KR); Seung Kyun Oh, Anyang (KR); Jeong Ho Song, Siheung (KR)

(21) Appl. No.: 19/330,535

(22) Filed: Sep. 16, 2025

(30) Foreign Application Priority Data
Mar. 18, 2025 (KR) 10-2025-0034362

(51) Int. Cl. C09D 5/18; C08G 77/08; C08G 77/12; C08G 77/20; C08K 3/22; C08K 7/28; C09D 7/61; C09D 183/04; C09K 5/14; H01M 10/613; H01M 10/653; H01M 10/6551

(52) U.S. Cl. CPC C09D 5/18; C08G 77/08; C08G 77/12; C08G 77/20; C09D 7/61; C09D 183/04; C09K 5/14; H01M 10/613; H01M 10/653; H01M 10/6551; C08K 2003/2227; C08K 7/28; C08K 2201/001

(57) ABSTRACT

A two-part, gap-filling silicone thermal interface material is disclosed. The main and curing agents each contain vinyl-terminated and hydrogen-terminated silicone resins blended with flame-retardant fillers and lightweight hollow particles. Keeping the hollow filler at 5-10 parts by weight and controlling the 1 rpm viscosity of each part to 2.5×10⁵ cP to 7.0×10⁵ cP (thixotropy 2.5-4.0) produces a paste that stores for 30 days without oil bleed, then dispenses smoothly through a 2 mm nozzle. After curing 24 h at 25° C., the material forms an electrically insulating body with >=3 Wm⁻¹K⁻¹ thermal conductivity, Shore 00 hardness 52-56, and apparent density <=1.9 g cm⁻³. Conductivity remains within 95% of its initial value after ageing 24 h at 100° C. The cured body serves as a lightweight, flame-retardant gap filler between battery cells or other heat sources and adjacent components, lowering interface resistance while maintaining long-term mechanical and thermal stability.

### CROSS REFERENCE TO RELATED APPLICATION

The present application claims under 35 U.S.C. § 119(a) the benefit of Korean Patent Application No. 10-2025-0034362, filed Mar. 18, 2025, the entire contents of which are incorporated herein for all purposes by this reference.

### BACKGROUND

### Technical Field

The present disclosure relates to a heat dissipation composition and, more specifically, relates to an electrical insulation-heat dissipation body and a heat dissipation structure that include the heat dissipation composition.

### Background

Conventional silicone-based resin heat dissipation composition suffers from a bleeding phenomenon in which a relatively low molecular weight silicone separates and migrates when the composition is stored for a long period of one month to six months. Accordingly, there is a disadvantage that a physical mixing process is required to be performed before a discharge process is performed after long-term storage.

In addition, after the conventional silicone-based resin composition is applied and then is heated, its viscosity decreased markedly, and the conventional silicone-based resin may behave like a liquid. Furthermore, when vibration or stirring is absent, inorganic particles may precipitate, so that uniform heat dissipation may not be realized.

### SUMMARY

Accordingly, the present disclosure was made keeping in mind the above problems occurring in the related art, and various embodiments are to provide a heat dissipation composition which does not require a physical mixing process before a discharging process is performed and which is lightweight, the heat dissipation composition having excellent long-term storage stability, heat dissipation characteristics, and discharge properties.

Various embodiments are to provide a heat dissipation composition capable of realizing a uniform heat dissipation effect without a separate vibration and stirring treatment after the heat dissipation composition is discharged and applied and then heated.

Various embodiments are not limited to the foregoing. Various embodiments will be able to be clearly understood through the following description and to be realized by the means described in the claims and combinations thereof.

There may be provided a heat dissipation composition including a main agent and a curing agent.

The main agent may include a vinyl-terminated first silicone-based resin, a catalyst, a first flame retardant filler, and a first hollow filler. The curing agent may include a vinyl-terminated second silicone-based resin, a hydrogen-terminated third silicone-based resin, a second flame retardant filler, and a second hollow filler. A viscosity of the main agent and a viscosity of the curing agent that are measured with a rotational viscometer under a condition of 25 degrees Celsius and 1 rpm may be equal to or less than 1,500,000 cP.

An electrical insulation-heat dissipation body may be formed by curing a mixture of the main agent and the curing agent. An electrical insulation-heat dissipation body may include a cured body derived from a mixture of the main agent and the curing agent.

Various embodiments do not require the physical mixing process before the discharging process is performed, and may be lightweight, so that the heat dissipation composition may be capable of realizing the excellent long-term storage stability, heat dissipation characteristics, and discharge properties.

In some embodiments, the first hollow filler is present in an amount of about 5 parts to about parts by weight per 100 parts by weight of the vinyl-terminated first silicone-based resin, and each of the main agent and the curing agent independently exhibits: a viscosity of 2.5×105 cP to 7.0×105 cP when measured at 1 rpm and 25° C. with a rotational viscometer; and a thixotropy index of 2.5 to 4.0, the index being the ratio of the viscosity at 1 rpm to the viscosity at 10 rpm at 25° C.

In some embodiments, after storage for 30 days at 20-30° C., the composition is continuously discharged through a 2 mm-diameter nozzle at 6 bar for 200 s without tailing, oil bleeding, or pore generation on the applied surface.

In some embodiments, a body cured from the composition for 24 h at 25° C. exhibits: a thermal conductivity of at least 3.0 W/mK at 25° C.; and a shore 00 hardness of 52 to 56.

In some embodiments, after ageing the cured body at 100° C. for 24 h, the terminal conductivity defined in claim 18 is retained within ±5% of its initial value and no surface cracking is observed.

In some embodiments, an electrical-insulation heat dissipation structure includes a cured body disposed as a gap-filler between a secondary battery cell or module and an adjacent member, wherein the cured body has an apparent density of 1.5 g/cm3 to 1.9 g/cm3 and maintains a thermal conductivity of at least 3.0 W/mK after storage for 30 days at 20-30° C.

The uniform heat dissipation effect may be capable of being realized without the separate vibration and stirring treatment after the heat dissipation composition is discharged and applied and then heated.

Various embodiments are not limited to the foregoing. It should be understood that the effects of various embodiments include all effects that can be inferred from the description of the present disclosure.

### BRIEF DESCRIPTION OF THE DRAWINGS

The above and other objectives, features, and other advantages of various embodiments will be more clearly understood from the following detailed description when taken in conjunction with the accompanying drawings.

FIG. 1 shows a state of a main agent composition of Comparative example 1 according to an evaluation of long-term storage stability in Experimental example 2.

FIG. 2 shows a state of a main agent composition of Comparative example 2 according to an evaluation of long-term storage stability in Experimental example 2.

FIG. 3 shows a state of a main agent composition of Reference example 1 according to an evaluation of long-term storage stability in Experimental example 2.

FIG. 4 shows a state of a main agent composition of Comparative example 3 according to an evaluation of long-term storage stability in Experimental example 2.

FIG. 5 shows a state of the main agent composition of Example 1 according to the evaluation of long-term storage stability in Experimental example 2.

FIG. 6 shows a state of the main agent composition of Example 2 according to the evaluation of long-term storage stability in Experimental example 2.

FIG. 7 shows a result of discharging a main agent and a curing agent of Comparative example 1 according to a specific condition in Experimental example 3 after the main agent and the curing agent are left for a long period of time.

FIG. 8 shows a result of discharging a main agent and a curing agent of Comparative example 3 according to a specific condition in Experimental example 3 after the main agent and the curing agent are left for a long period of time.

FIG. 9 shows a result of discharging a main agent and a curing agent of Example 1 according to a specific condition in Experimental example 3 after the main agent and the curing agent are left for a long period of time.

FIG. 10 shows a curing state of a cured heat dissipation body test specimen in Experimental example 4 after the main agent and the curing agent of Comparative example 1 is left for a long period of time.

FIG. 11 shows a curing state of a cured heat dissipation body test specimen in Experimental example 4 after the main agent and the curing agent of Comparative example 2 is left for a long period of time.

FIG. 12 shows a curing state of a cured heat dissipation body test specimen in Experimental example 4 after the main agent and the curing agent of Example 1 is left for a long period of time.

FIG. 13 shows a curing state of a cured heat dissipation body test specimen in Experimental example 4 after the main agent and the curing agent of Example 2 is left for a long period of time.

FIG. 14 shows a curing state of a cured heat dissipation body test specimen in Experimental example 4 after the main agent and the curing agent of Reference example 1 is left for a long period of time.

FIG. 15 shows a curing state of a cured heat dissipation body test specimen in Experimental example 4 after the main agent and the curing agent of Comparative example 3 is left for a long period of time.

FIG. 16 shows an application of the main agent according to an aspect of the present disclosure after the main agent is left for 15 days.

FIG. 17 shows an application of a commercially available main agent composition having a two-component silicone-based resin after the commercially available main agent composition is left for 15 days.

FIG. 18 shows the main agent according to various embodiments after the main agent is left for 15 days.

FIG. 19 shows the main agent according to various embodiments after the main agent is left for 130 days.

FIG. 20 shows the commercially available main agent composition having the two-component silicone-based resin after the commercially available main agent composition is left for 15 days.

FIG. 21 shows the commercially available main agent composition having the two-component silicone-based resin after the commercially available main agent composition is left for 130 days.

### DETAILED DESCRIPTION

Above objectives, other objectives, features, and advantages of various embodiments will be readily understood from the following preferred embodiments associated with the accompanying drawings. However, various aspects are not limited to the embodiments described herein and may be embodied in other forms. Various embodiments described herein are provided so that various embodiments can be made thorough and complete and that the spirit of various embodiments can be fully conveyed to those skilled in the art.

While describing each drawing, similar reference numerals have been used for similar components. In the drawings, the thicknesses of certain lines, layers, components, elements, or features may be exaggerated for clarity. Terms “first”, “second”, and so on can be used to describe various elements, but the elements are not to be construed as being limited to the terms. The terms are used only for the purpose of distinguishing one constituent element from another constituent element. For example, a first element may be termed a second element, and a second element may be termed a first element, without departing from the scope of the present disclosure. Singular expressions include plural expressions unless the context clearly indicates otherwise.

In the present specification, it is to be understood that terms such as “including”, “having”, and so on are intended to indicate the existence of the features, numbers, steps, actions, elements, components, or combinations thereof disclosed in the specification, and are not intended to preclude the possibility that one or more other features, numbers, steps, actions, elements, components, or combinations thereof may exist or may be added. In addition, it will also be understood that when a layer, a film, a region, a plate, etc. is referred to as being “on” or “above” another part, it can be “directly on” the other part, or intervening layers may also be present. On the contrary, it will also be understood that when a layer, a film, a region, a plate, etc. is referred to as being “under” or “below” another part, it can be “directly under” the other part, or intervening layers may also be present.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases.

Furthermore, when a numerical range is disclosed in this specification, the range is continuous and includes all values from the minimum value of said range to the maximum value thereof, unless otherwise indicated. Moreover, when such a range pertains to integer values, all integers including the minimum value to the maximum value are included, unless otherwise indicated.

Heat Dissipation Composition A heat dissipation composition may include a main agent and a curing agent.

The main agent may include a vinyl-terminated first silicone-based resin, a catalyst, a first flame retardant filler and a first hollow filler.

The curing agent may include a vinyl-terminated second silicone-based resin, a hydrogen-terminated third silicone-based resin, a second flame retardant filler and a second hollow filler.

A viscosity of the main agent and the viscosity of the curing agent that are measured with a rotational viscometer under a condition of 25 degrees Celsius and 1 rpm may be equal to or less than 1,500,000 cP.

The heat dissipation composition may be a two-component composition in which the main agent and the curing agent are separately divided until the main agent and the curing agent are applied to a heat dissipation target.

The heat dissipation composition may be used by being disposed or filled in at least a portion of a gap between a heating element and a member positioned adjacent to the heating element and may be applied to a region where electrical insulation and thermal conductivity are required. The heat dissipation composition may be used as a gap filler, a thermally conductive paste, a thermal pad, and so on. The member positioned adjacent to the heating element may be a member having a predetermined gap with the heating element or may be a housing that closes the heating element.

The main agent may be distinguished from the curing agent in that the main agent may include a catalyst and the curing agent may include a hydrogen-terminated silicone-based resin, and the main agent and the curing agent may be interchanged according to a situation. The main agent and the curing agent are mixed, curing may be started as the vinyl-terminated silicone-based resin (oligomer or prepolymer) polymerizes with the hydrogen-terminated silicone-based resin (oligomer or prepolymer) due to an effect of the catalyst.

Each of the vinyl-terminated first silicone-based resin of the main agent and the vinyl-terminated second silicone-based resin of the curing agent may include a vinyl-terminated portion at a portion other than a dimethylsiloxane repeating unit and may include vinyl-terminated polydimethylsiloxane having a structure as in Chemical Formula 1.

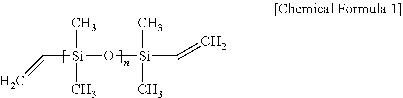

The first silicone-based resin and the second silicone-based resin may be in a prepolymer state or in an oligomer state, may have a weight average molecular weight that allows the main agent or the curing agent mixed with each component to maintain a liquid state with a predetermined viscosity, and may have a weight average molecular weight of 6,000 g/mol to 82,000 g/mol as an example. Having such a weight average molecular weight may contribute to the main agent and the curing agent to have stable discharge properties and coating uniformity.

Each of the vinyl-terminated first silicone-based resin and the vinyl-terminated second silicone-based resin may be a mixture of vinyl-terminated resins having different molecular weights. For example, each of the vinyl-terminated first silicone-based resin and the vinyl-terminated second silicone-based resin may be a mixture in which a vinyl-terminated resin having a weight average molecular weight of 6,000 g/mol to 13,000 g/mol and a vinyl-terminated resin having a weight average molecular weight of 75,000 g/mol to 82,000 g/mol are mixed with a weight ratio of 1:0.1 to 1:10.

The vinyl-terminated first silicone-based resin and the vinyl-terminated second silicone-based resin may be the same material or may have the molecular weights different from each other.

A molar ratio of a Si-methyl group and a Si-vinyl group of each of the vinyl-terminated first silicone-based resin and the vinyl-terminated second silicone-based resin may be 1:0.005 to 1:0.05 or may be 1:0.008 to 1:0.02.

The hydrogen-terminated third silicone-based resin may include a hydrogen-terminated dimethylsiloxane-methylhydrosiloxane copolymer having a structure similar to that of Chemical Formula 2 as an example.

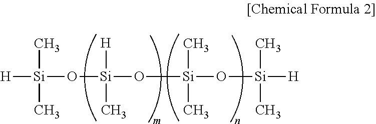

The hydrogen-terminated third silicone-based resin may include hydrogen-terminated poly(dimethylsiloxane) at both ends, poly(methylhydrosiloxane) with a linear structure represented by the formula (CH₃)₃SiO[(CH₃)HSiO]ₙSi(CH₃)₃, trimethylsilyl group-terminated poly(dimethylsiloxane-co-methylhydrosiloxane) at both ends, and so on.

The weight average molecular weight of the hydrogen-terminated third silicone-based resin may be 1,000 g/mol to 7,500 g/mol, and may be 3,500 g/mol to 5,000 g/mol. Having such a molecular weight may contribute to the curing agent to have an appropriate viscosity and may contribute to the curing agent to have stable discharge properties and coating uniformity.

In the silicone-based resin (the second silicone-based resin and the third silicone-based resin) in the curing agent, the molar ratio of Si-vinyl and Si-hydrogen may be 1:0.001 to 1:0.6, may be 1:0.01 to 1:0.5, and may be 1:0.1 to 1:0.5. By having this range, when the curing agent is applied to a heat dissipation target, the curing and filling may be stably performed.

The main agent may include 10 to 40 parts by weight of the vinyl-terminated first silicone-based resin, 0.01 to 3 parts by weight of the catalyst, 40 to 80 parts by weight of the first flame retardant filler and 1 to 10 parts by weight of the first hollow filler.

The main agent may include 13 to 40 parts by weight of the vinyl-terminated first silicone-based resin, 0.1 to 3 parts by weight of the catalyst, 47 to 75 parts by weight of the first flame retardant filler and 3 to 10 parts by weight of the first hollow filler.

The weight ranges of each component in the main agent may or may not be based on 100 parts by weight of the main agent according to a situation.

As the main agent includes the vinyl-terminated first silicone-based resin in the above-mentioned parts by weight, the main agent may be maintained in a liquid state with a predetermined viscosity, and the main agent may have appropriate discharge properties and coating uniformity.

As the main agent includes the catalyst in the above-mentioned parts by weight, stable curing and polymerization of the main agent may be realized when the main agent is mixed with the curing agent.

As the main agent includes the first flame retardant filler in the above-mentioned parts by weight, a heat dissipation body manufactured by mixing the main agent with the curing agent may maintain an appropriate flame retardant level, and a degradation in the discharge properties may be prevented.

As the main agent includes the first hollow filler in the above-mentioned parts by weight, the main agent may have a long-term storage stability and the discharge properties, the heat dissipation body manufactured by mixing the main agent with the curing agent may have a relatively low density, and a degradation in the thermal conductivity may be minimized.

The first hollow filler of the main agent may also include 6 to 10 parts by weight of the first hollow filler and may include 7 to 9 parts by weight of the first hollow filler.

The curing agent may include 10 to 40 parts by weight of the vinyl-terminated second silicone-based resin, 1 to 10 parts by weight of the hydrogen-terminated third silicone-based resin, 40 to 80 parts by weight of the second flame retardant filler and 0.1 to 10 parts by weight of the second hollow filler.

The curing agent may include 13 to 40 parts by weight of the vinyl-terminated second silicone-based resin, 3 to 10 parts by weight of the hydrogen-terminated third silicone-based resin, 47 to 75 parts by weight of the second flame retardant filler and 3 to 10 parts by weight of the second hollow filler.

As the curing agent includes the vinyl-terminated second silicone-based resin in the above-mentioned parts by weight, the curing agent may be maintained in a liquid state with a predetermined viscosity, and the curing agent may have appropriate discharge properties and coating uniformity.

As the curing agent includes the hydrogen-terminated third silicone-based resin in the above-mentioned parts by weight, stable curing and polymerization of the curing agent may be realized when the curing agent is mixed with the main agent.

As the curing agent includes the second flame retardant filler in the above-mentioned parts by weight, the heat dissipation body manufactured by mixing the curing agent with the main agent may maintain an appropriate flame retardancy level, and a degradation in the discharge properties may be prevented.

As the curing agent includes the second hollow filler in the above-mentioned parts by weight, the curing agent may have a long-term storage stability and the discharge properties, the heat dissipation body manufactured by mixing the curing agent with the main agent may have a relatively low density, and a degradation in the thermal conductivity may be minimized.

The second hollow filler of the curing agent may also include 6 to 10 parts by weight of the second hollow filler and may include 7 to 9 parts by weight of the second hollow filler.

In order for the main agent and the curing agent to have substantially similar properties such as the viscosity, the discharge properties, the storage stability, and so on, the remaining components except the catalyst and the hydrogen-terminated third silicone-based resin may be mixed with a similar weight ratio.

The viscosity of each of the main agent and the curing agent measured with a rotational viscometer under a condition of 25 degrees Celsius and 1 rpm may be equal to or less than 1,500,000 cP, may be equal to or less than 1,200,000 cP, may be equal to or less than 900,000 cP, and may be equal to or less than 700,000 cP. The viscosity may be at least 220,000 cP, may be at least 300,000 cP, and may be at least 400,000 cP. Since the main agent and the curing agent have such viscosity, a thickness and a shape for which the discharged liquid is intended may be maintained, an application surface may be regularly formed, and excellent discharge properties may be secured.

A thixotropy index of each of the main agent and the curing agent measured by the rotational viscometer may be equal to or less than 8, may be equal to or less than 6.5, may be equal to or less than 5, may be equal to or less than 4.5, and may be equal to or less than 4.2 The thixotropy index described below may be at least 1.5, may be at least 2.5, may be at least 2.8, and may be at least 3.

The thixotropy index=(a viscosity of a fluid under a condition of 25 degrees Celsius and 1 rpm/a viscosity of the fluid under a condition of 25 degrees Celsius and 10 rpm) Since the main agent and the curing agent have such a thixotropy index, the storage stability may be secured by preventing large pores (air gaps) from occurring during storing and packaging, the thickness and the shape for which the discharge liquid is intended may be maintained during discharging, and excellent discharge properties may be secured.

The catalyst of the main agent may include a catalyst metal particle and may include a catalyst metal supported on a carrier. The carrier may be a porous material and may be a carbon-based material or carbon black as an example.

The catalyst metal may include one or more of platinum, palladium, rhodium, iridium, nickel, ruthenium, copper and silver. The catalyst metal may include platinum.

Each of the first flame retardant filler in the main agent and the second flame retardant filler in the curing agent may include one or more of aluminum hydroxide, aluminum oxide, aluminum nitride, magnesium hydroxide, magnesium oxide, calcium hydroxide, calcium carbonate, boron nitride and titanium dioxide. A material having a relatively low density and maintaining a flame retardancy level of V-0 according to UL94 may be applied as the first flame retardant filler and the second flame retardant filler, and aluminum hydroxide, magnesium hydroxide, or calcium hydroxide may be applied as the first flame retardant filler and the second flame retardant filler.

Each of the first flame retardant filler and the second flame retardant filler may have a D50 particle size of 1 μm to 100 μm and may have a D50 particle size of 10 μm to 80 μm. In the present specification, the D50 particle size may be a particle size at which a cumulative volume reaches 50% in a particle size-volume cumulative distribution curve.

Each of the first hollow filler and the second hollow filler may include a hollow particle. The hollow particle may include no more than two large pores inside the particle and may include a single hollow portion.

The hollow particle may include one or more of glass, polypropylene, polystyrene, aluminum oxide, silicon oxide and zirconium oxide. The hollow particle may include glass.

The glass may include soda-lime glass, borosilicate glass, soda-lime-borosilicate glass in which boron oxide is added to soda-lime glass, aluminosilicate glass, lead glass, phosphate glass, and the so on.

The D50 particle size of the hollow glass particle including the glass may be 10 μm to 100 μm, and may be 20 μm to 60 μm. Since the hollow glass particle has the D50 particle size described above, defects such as filler scattering and burrs after curing of the main agent and the curing agent may be minimized, and appropriate discharge properties may be secured since the hollow glass particle prevents a phase separation of low molecular weight oil.

The apparent density of the hollow glass particle may be 0.2 g/cm³ to 0.78 g/cm³. By having such an apparent density, the heat dissipation composition and the cured heat dissipation body may be made lightweight, and the appropriate discharge properties and the appropriate storage stability may be secured.

The apparent density of each of the main agent and the curing agent may be equal to or less than 1.9 g/cm³, may be equal to or less than 1.7 g/cm³, and may be at least than 1 gcm³.

The heat dissipation body acquired by polymerization of the main agent and the curing agent may have a slightly increased apparent density, but the apparent density may not be substantially different from the error range (±5%) of the density of each of the main agent and the curing agent.

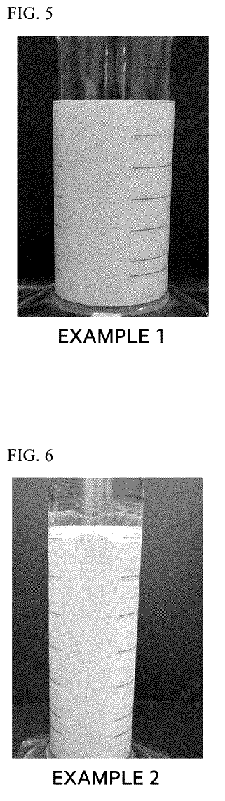

FIG. 5A is a photograph of an application of the main agent according to an aspect of the present disclosure after the main agent is left for 15 days, and FIG. 6A is a photograph of the main agent according to an aspect of the present disclosure after the main agent is left for 15 days and for 130 days. Referring to the drawings, even when the main agent and the curing agent are left in a closed storage space for 30 days, a so-called bleeding phenomenon in which oil containing low molecular weight silicone-based compounds is separated on a surface may not occur. When the main agent and the curing agent of the heat dissipation composition are left in the closed storage space for 130 days, the volume of the separated oil having the low molecular weight based on the total volume may be equal to or less than 5 volume %, may be equal to or less than 3 volume %, and may be at least 0.1 volume %.

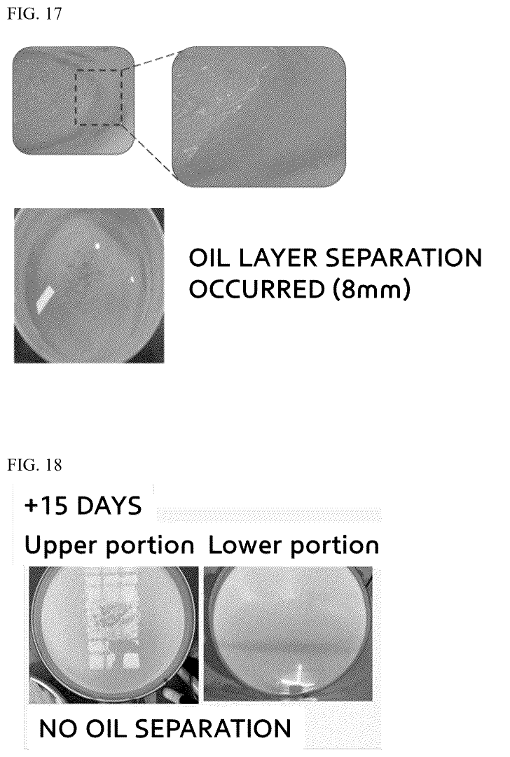

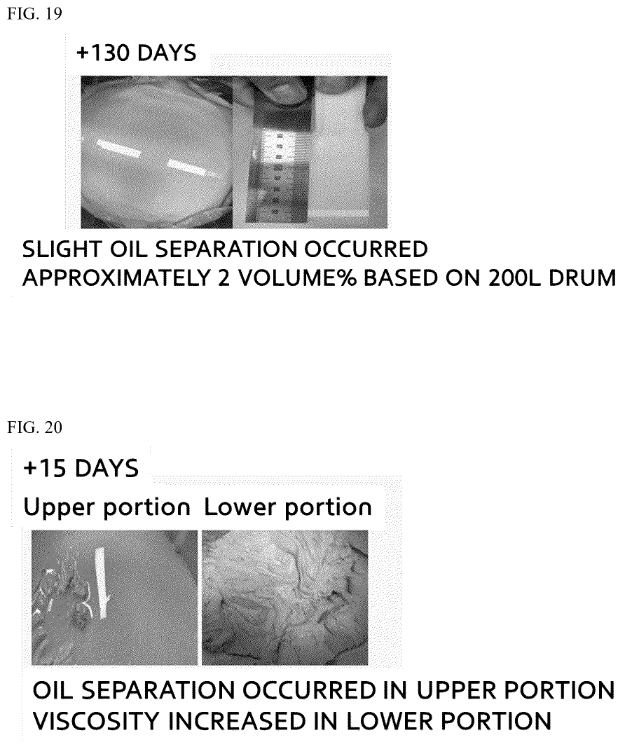

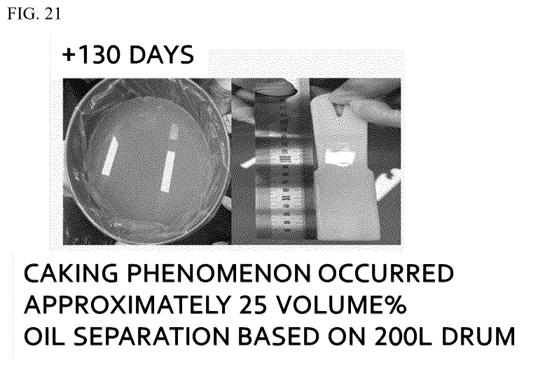

FIG. 17 shows an application of a commercially available main agent composition having a two-component silicone-based resin after the commercially available main agent composition is left for 15 days, and FIGS. 20 and 21 are the commercially available main agent composition having the two-component silicone-based resin after the commercially available main agent composition is left for 15 days and for 130 days, respectively. Referring to the drawings, after 15 days have elapsed, it was confirmed that the separation of the oil was formed, and that the viscosity of a lower portion of the commercially available main agent composition has increased. In addition, after 130 days have elapsed, it was confirmed that the volume of the separated oil having the low molecular weight based on the total volume is 25 volume %.

In addition, the oil, which is an oil layer, may be distinguished from a non-oil component by a visible light transmittance, and the oil may have a relatively large visible light transmittance.

The main agent and the curing agent may be mixed according to the weight ratio of each component described above and may be mixed in a weight ratio of 1:1.

### Electrical Insulation-Heat Dissipation Body

An electrical insulation-heat dissipation body according to an aspect of the present disclosure may be formed by curing the mixture of the main agent and the curing agent of the heat dissipation composition.

The electrical insulation-heat dissipation body may equally include components other than a polymer derived from the silicone-based resins of the heat dissipation composition, as well as unreacted components.

Descriptions of each component of the main agent and the curing agent and the weight ratios of their mixtures will be omitted so as to avoid redundancy as they have been previously described.

The curing may be performed at a temperature of 20 degrees Celsius to 35 degrees Celsius, and the curing may be promoted at room temperature (20 degrees Celsius to 25 degrees Celsius) by the catalyst without applying heat through a separate heating mechanism.

The curing may be performed for 6 hours to 48 hours and may be performed for 12 hours to 36 hours.

The electrical insulation-heat dissipation body may have a thermal conductivity at 25 degrees Celsius of at least 2.8 W/mK, and the thermal conductivity may be at least 3 W/mK and may be at least 3.2 W/mK. The thermal conductivity may be equal to or less than 5 W/mK. Although the electrical insulation-heat dissipation body includes the flame retardant filler, the hollow filler, and so on, the thermal conductivity loss may be minimized, and the electrical insulation-heat dissipation body may have an appropriate thermal conductivity and heat transfer characteristics.

The apparent density of the electrical insulation-heat dissipation body may be equal to or less than 1.9 g/cm³, may be equal to or less than 1.7 g/cm³, and may be at least 1 g/cm³. Having such an apparent density may contribute to the weight reduction of a product to which the electrical insulation-heat dissipation body is applied.

A shore OO hardness of the electrical insulation-heat dissipation body may be equal to or less than 70, may be equal to or less than 60, may be at least 40, and may be at least 50.

The UL94 flame retardancy level of the electrical insulation-heat dissipation body may correspond to V-0, and the electrical insulation-heat dissipation body may have a flame retardancy level equal to or higher than 5 VB.

According to ISO-6469-3 standard, when the electrical insulation-heat dissipation body is disposed such that the electrical insulation-heat dissipation body is filled and is in contact with an aluminum module case and a plurality of battery cells and then a voltage of 3 kV is applied to the battery cells for one seconds, an evaluated leakage current may be equal to or less than 165 mA, may be equal to or less than 150 mA, and may be at least 10 mA.

### Heat Dissipation Structure

A heat dissipation structure according to an aspect of the present disclosure may include the electrical insulation-heat dissipation body disposed between a heating element and a member.

The electrical insulation-heat dissipation body may be in contact with the heating element and the member and may transfer heat of the heating element to the member through direct thermal conduction.

The heating element may include a semiconductor device, a resistor, a power supply component, an energy storage device, and so on, and may include the energy storage device, a secondary battery cell, a secondary battery module, and so on as an example.

The member may be a heat dissipation member, and may include a heat sink, a heat pipe, a radiator, a housing, and so on.

Various embodiments will be described in detail with reference to the followings. However, the technical ideas of various embodiments are not restricted or limited thereto.

### Example 1

A composition including the main agent and the curing agent as described below was prepared.

1) main agent including:
30 parts by weight of vinyl-terminated polydimethylsiloxane resin with Mw of 30,000 g/mol;
1 part by weight of platinum catalyst;
60 parts by weight of aluminum hydroxide as the first flame retardant filler with D50 particle size of 60 μm; and
5 parts by weight of soda-lime-borosilicate glass as the first hollow filler (Glass Bubbles VS5500, 3M) with D50 particle size of 44 μm and apparent density of 0.38 g/cm³.

2) curing agent including:
30 parts by weight of vinyl-terminated polydimethylsiloxane resin with Mw of 30,000 g/mol;
5 parts by weight of hydrogen-terminated poly(dimethylsiloxane-co-methylhydrosiloxane) resin with Mw of 5,000 g/mol;
60 parts by weight of aluminum hydroxide as the second flame retardant filler with D50 particle size of 60 μm; and
5 parts by weight of soda-lime-borosilicate glass as the second hollow filler (Glass Bubbles VS5500, 3M) with D50 particle size of 44 μm and apparent density of 0.38 g/cm³.

### Other Examples, Comparative Examples, and Reference Examples

Following compositions were prepared by varying the content of some components in Example 1.

Comparative example 1: The composition was the same as Example 1, except that the first hollow filler and the second hollow filler were not added.

Comparative example 2: The composition was the same as Example 1, except that the weight of each of the first hollow filler and the second hollow filler was changed to 0.8 parts by weight.

Example 2: The composition was the same as Example 1, except that the weight of each of the first hollow filler and the second hollow filler was changed to 6.4 parts by weight.

Reference example 1: The composition was the same as Example 1, except that the weight of each of the first hollow filler and the second hollow filler was changed to 12 parts by weight.

Comparative example 3: The composition was the same as Example 1, except that the weight of each of the first hollow filler and the second hollow filler was changed to 24 parts by weight.

### Experimental Example 1—Measurement of Viscosity, Thixotropy Index, Hardness of Cured Heat Dissipation Body, and Thermal Conductivity

The viscosity and the thixotropy index of each of Example 1, Example 2, Comparative example 1, Comparative example 2, Comparative example 3, and Reference example 1 were measured as described below, the Shore 00 hardness of the cured heat dissipation body and the thermal conductivity were measured, and the results are shown in Table 1.

Viscosity: The viscosity of each fluid is measured by using a rotational viscometer under a condition of 25 degrees Celsius, 1 rpm, and 10 rpm.

Thixotropy Index (TI): Calculated as (a viscosity of a fluid under a condition of 25 degrees Celsius and 1 rpm/a viscosity of the fluid under a condition of 25 degrees Celsius and 10 rpm).

Curing: Treated at a temperature of 25 degrees Celsius for one day

TABLE 1

| | Comparative | Comparative | | | Reference | Comparative |
|---|---|---|---|---|---|---|
| Separation | example 1 | example 2 | Example 2 | Example 1 | example 1 | example 3 |
| Hollow filler | 0 | 0.8 | 6.4 | 8 | 12 | 24 |
| Parts by | | | | | | |
| weight | | | | | | |
| Main agent | 190,000 | 210,000 | 420,000 | 576,000 | 762,000 | 1,950,000 |
| viscosity | | | | | | |
| (cP, 1 rpm) | | | | | | |
| Curing agent | 210,000 | 234,000 | 460,000 | 584,000 | 791,000 | 1,960,000 |
| viscosity | | | | | | |
| (cP, 1 rpm) | | | | | | |
| Main agent | 80,000 | 91,000 | 132,000 | 156,000 | 188,000 | 371,200 |
| viscosity | | | | | | |
| (cP, 10 rpm) | | | | | | |
| Curing agent | 96,000 | 100,000 | 139,000 | 160,000 | 207,000 | 374,000 |
| viscosity | | | | | | |
| (cP, 10 rpm) | | | | | | |
| Main agent | 2.375 | 2.307 | 3.182 | 3.7 | 4.053 | 5.3 |
| Thixotropy | | | | | | |
| Index | | | | | | |
| Curing agent | 2.1875 | 2.340 | 3.309 | 3.7 | 3.821 | 5.2 |
| Thixotropy | | | | | | |
| Index | | | | | | |
| Shore 00 | 52 | 52 | 54 | 56.2 | 58 | 62 |
| hardness | | | | | | |
| Thermal | 3.4 | 3.3 | 3.1 | 3.2 | 2.8 | 1.8 |
| conductivity | | | | | | |
| (W/mK) | | | | | | |

It was confirmed that Examples, and Comparative examples 1 and 2 have good thermal conductivity, and Reference example 1 show a slightly reduced thermal conductivity.

In addition, it was confirmed that Examples have a viscosity and a thixotropy index suitable for discharging.

### Experimental Example 2—Evaluation of Long-Term Storage Stability (30 Days)

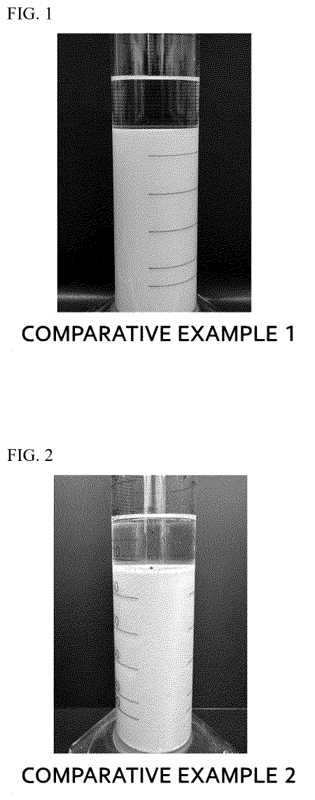

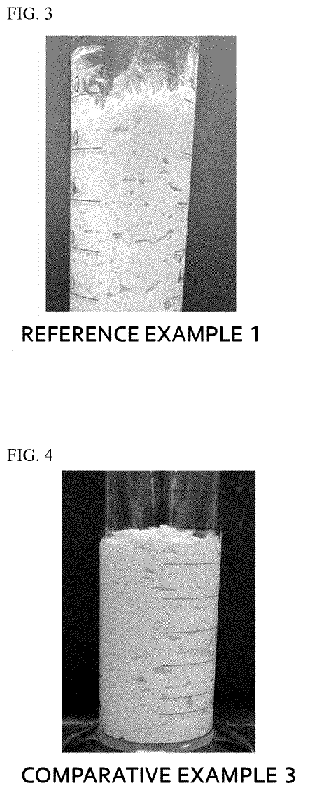

The main agents of Example 1, Example 2, Comparative example 1, Comparative example 2, Comparative example 3, and Reference example 1 were stored in a cylinder for 30 days at a temperature of 20 degrees Celsius to 30 degrees Celsius, and a subsequent state is shown in FIG. 1 to FIG. 6.

Comparative examples 1 and 2 showed a bleeding phenomenon of transparent low molecular weight oil, whereas Example 1 and 2 showed almost no substantial bleeding phenomenon. Reference example 1 and Comparative example 3 did not show the bleeding phenomenon, but pores were generated due to high viscosity and thixotropy index.

### Experimental Example 3—Evaluation of Discharge Properties after Long-Term Storage (30 Days)

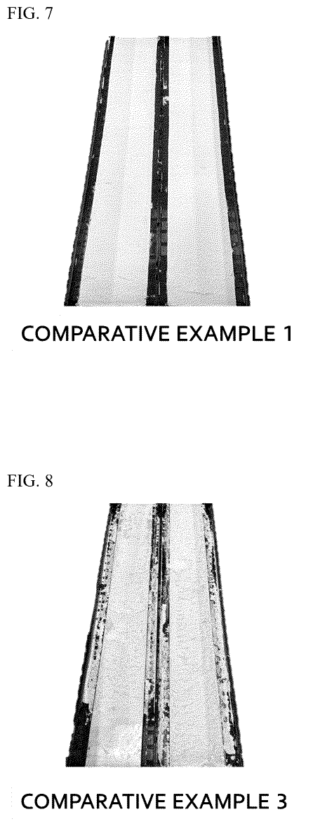

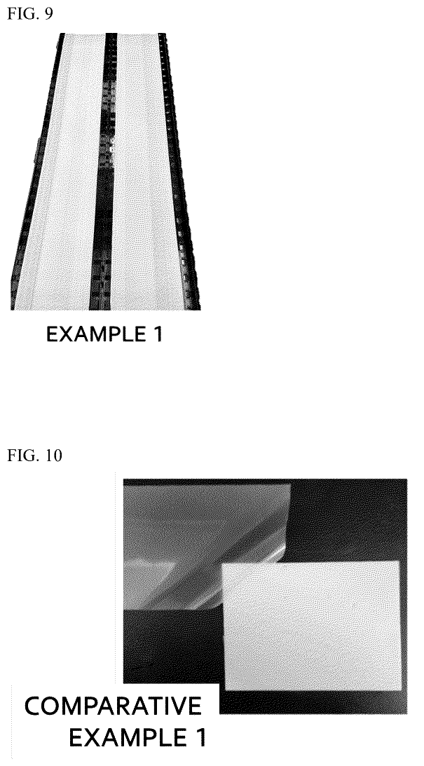

The main agents and the curing agents of Example 1, Comparative example 1, and Comparative example 3 were stored for 30 days at a temperature of 20 degrees Celsius to 30 degrees Celsius, were discharged through a mobile dispenser with a discharge amount of 100 cc, a discharge pressure of 6 bar, and a discharge time of 20 seconds, and the results are shown in FIG. 7 to FIG. 9.

In Comparative example 3, the viscosity and the thixotropy index were high, so that the discharge was irregularly performed due to excessive discharge pressure, and practical application was difficult to be performed.

Comparative Example 1, which did not include the hollow filler, had low viscosity, and a tailing phenomenon in which a discharge liquid excessively flows when the discharge liquid is discharged with a dispenser was generated, so that an irregular application surface was generated.

It was confirmed that the discharge was stably performed in Example 1, so that a regular application surface was generated.

### Experimental Example 4—Curing Stability Evaluation after Long-Term Storage (30 Days)

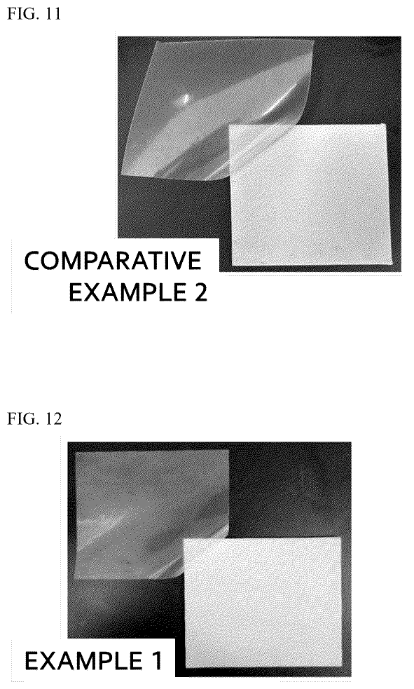

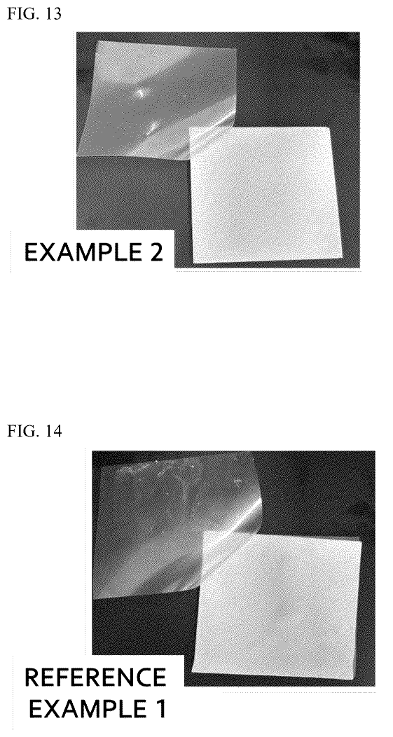

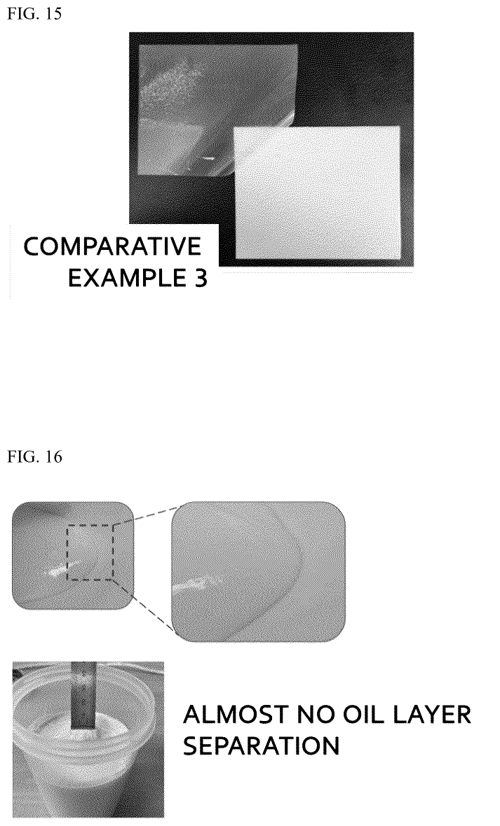

After the main agents and the curing agents of Example 1, Example 2, Comparative example 1, Comparative example 2, Comparative example 3, and Reference example 1 were stored for 30 days at a temperature of 20 degrees Celsius to 30 degrees Celsius, the main agents and the curing agents of each of the examples were applied on a predetermined region such that the main agents and the curing agents were mixed with each other, and then the mixture of each of the example was covered with a fluororesin-coated release film and was cured for one day at a temperature of 25 degrees Celsius. Then, the release film was removed from each heat dissipation body test specimen that is cured, the presence or absence of foreign substances in the release film was visually evaluated, and the results are shown in FIG. 10 to FIG. 15.

The curing was stably performed in Comparative example 1, Comparative example 2, and Examples, and separation of some fillers and burrs and residue were generated in Reference example 1 and Comparative example 3.

Although various embodiments have been described for illustrative purposes, those skilled in the art will appreciate that various modifications, additions and substitutions are possible, without changing the spirit or essential features of the present disclosure. Therefore, it should be understood that the embodiments described above are illustrative in all respects and not restrictive.

What is claimed is:

1. A heat dissipation composition comprising:
a main agent; and
a curing agent,
wherein the main agent comprises: a vinyl-terminated first silicone-based resin; a catalyst; a first flame retardant filler; and a first hollow filler,
wherein the curing agent comprises: a vinyl-terminated second silicone-based resin; a hydrogen-terminated third silicone-based resin; a second flame retardant filler; and a second hollow filler, and
wherein a viscosity of the main agent and a viscosity of the curing agent that are measured with a rotational viscometer under a condition of 25 degrees Celsius and 1 rpm are equal to or less than 1,500,000 cP.

2. The heat dissipation composition of claim 1, wherein the heat dissipation composition is applied as a gap filler between a heating element and a member positioned adjacent the heating element.

3. The heat dissipation composition of claim 1, wherein the main agent comprises:
about 10 to 40 parts by weight of the vinyl-terminated first silicone-based resin;
about 0.01 to 3 parts by weight of the catalyst;
about 40 to 80 parts by weight of the first flame retardant filler; and
about 1 to 10 parts by weight of the first hollow filler.

4. The heat dissipation composition of claim 1, wherein the curing agent comprises:
about 10 to 40 parts by weight of the vinyl-terminated second silicone-based resin;
about 1 to 10 parts by weight of the hydrogen-terminated third silicone-based resin;
about 40 to 80 parts by weight of the second flame retardant filler; and
about 1 to 10 parts by weight of the second hollow filler.

5. The heat dissipation composition of claim 1, wherein a thixotropy index (=a viscosity of a fluid under a condition of 25 degrees Celsius and 1 rpm/a viscosity of the fluid under a condition of 25 degrees Celsius and 10 rpm) of each of the main agent and the curing agent measured with the rotational viscometer is equal to or less than 8.

6. The heat dissipation composition of claim 1, wherein the catalyst comprises a catalyst metal, and the catalyst metal comprises one or more of platinum, palladium, rhodium, iridium, nickel, ruthenium, copper and silver.

7. The heat dissipation composition of claim 1, wherein each of the first flame retardant filler and the second flame retardant filler comprises one or more of aluminum hydroxide, aluminum oxide, aluminum nitride, magnesium hydroxide, magnesium oxide, calcium hydroxide, calcium carbonate, boron nitride and titanium dioxide.

8. The heat dissipation composition of claim 1, wherein each of the first hollow filler and the second hollow filler comprises a hollow particle, and
wherein the hollow particle comprises one or more of glass, polypropylene, polystyrene, aluminum oxide, silicon oxide and zirconium oxide.

9. The heat dissipation composition of claim 8, wherein the hollow particle comprises glass, and an apparent density of the hollow particle is about 0.2 g/cm³ to 0.78 g/cm³.

10. The heat dissipation composition of claim 1, wherein an apparent density of the heat dissipation composition is equal to or less than about 1.9 g/cm³.

11. An electrical insulation-heat dissipation body comprising a cured body derived from a mixture of the main agent and the curing agent of claim 1.

12. The electrical insulation-heat dissipation body of claim 11, wherein a thermal conductivity of the electrical insulation-heat dissipation body at 25 degrees Celsius is at least about 2.8 W/mK.

13. The electrical insulation-heat dissipation body of claim 11, wherein an apparent density of the electrical insulation-heat dissipation body is equal to or less than about 1.9 g/cm³.

14. A heat dissipation structure comprising the electrical insulation-heat dissipation body of claim 11, the electrical insulation-heat dissipation body being disposed between a heating element and a member.

15. The heat dissipation structure of claim 14, wherein the heating element comprises a secondary battery cell or a secondary battery module.

16. The heat dissipation composition of claim 1, wherein the first hollow filler is present in an amount of about 5 parts to about 10 parts by weight per 100 parts by weight of the vinyl-terminated first silicone-based resin, and
each of the main agent and the curing agent independently exhibits:
a viscosity of 2.5×10⁵ cP to 7.0×10⁵ cP when measured at 1 rpm and 25° C. with a rotational viscometer; and
a thixotropy index of 2.5 to 4.0, the index being the ratio of the viscosity at 1 rpm to the viscosity at 10 rpm at 25° C.

17. The heat dissipation composition of claim 16, wherein, after storage for 30 days at 20-30° C., the composition is continuously discharged through a 2 mm-diameter nozzle at 6 bar for 200 s without tailing, oil bleeding, or pore generation on the applied surface.

18. The heat dissipation composition of claim 16, wherein a body cured from the composition for 24 h at 25° C. exhibits:
a thermal conductivity of at least 3.0 W/mK at 25° C.; and
a shore 00 hardness of 52 to 56.

19. The heat dissipation composition of claim 18, wherein, after ageing the cured body at 100° C. for 24 h, the terminal conductivity is retained within ±5% of its initial value and no surface cracking is observed.

20. An electrical-insulation heat dissipation structure comprising a cured body obtained from the composition of claim 16, the cured body being disposed as a gap-filler between a secondary battery cell or module and an adjacent member,
wherein the cured body has an apparent density of 1.5 g/cm³ to 1.9 g/cm³ and maintains a thermal conductivity of at least 3.0 W/mK after storage for 30 days at 20-30° C.
